(19) United States
(12) Patent Application Publication
(10) Pub. No.: US 2026/0273869 A1
(43) Pub. Date: Sep. 17, 2026

(54) SYSTEM AND METHOD OF MAKING AN ARTIFICIAL STONE HAVING A CONTROLLED THICKNESS

(71) Applicant: CAESARSTONE LTD., Kibbutz Sdot-Yam (IL)

(72) Inventor: Erez MARGALIT, Moshav Merhavia (IL)

(73) Assignee: CAESARSTONE LTD., Kibbutz Sdot-Yam (IL)

(21) Appl. No.: 19/480,268

(22) PCT Filed: May 2, 2024
(86) PCT No.: PCT/IL2024/050417

§ 371 Date: Oct. 30, 2025

(30) Foreign Application Priority Data
May 2, 2023 (IL) 302601

(51) Int. Cl. B29C 67/24; B28B 3/12; B28B 5/02; B28B 13/02; B29L 7/00

(52) U.S. Cl. CPC B29C 67/245; B28B 3/12; B28B 5/027; B28B 13/0275; B28B 13/0295; B29L 2007/002

(57) ABSTRACT

A system for making an artificial stone is disclosed. The system comprises: a weighing and dosing unit; an upper conveyor positioned to receive an artificial stone mixture from a bottom exit of the weighing and dosing unit, wherein the artificial stone mixture comprises an inorganic filler and a polymeric binder; a lower conveyor, located partially under the upper conveyor, positioned to receive the artificial stone mixture from the upper conveyor; and a crushing cylinder located against distal rotating axes of the lower conveyor at a distance of 1 to 20 mm from the lower conveyor, rotating at a tangential speed which is at least twice higher than the speed of the lower conveyor, wherein the crushing cylinder is configured to lay and unify the artificial stone mixture on a final conveyor.

### CROSS-REFERENCE TO RELATED-APPLICATIONS

This application claims the benefit of priority of Israeli Patent Application No. 302601, titled “SYSTEM AND METHOD OF MAKING AN ARTIFICIAL STONE HAVING A CONTROLLED THICKNESS”, filed 2 May 2023, the contents of which is incorporated herein by reference in its entirety.

### FIELD OF THE INVENTION

The present invention relates generally to slabs from artificial stones. More specifically, the present invention relates to a system and method of making an artificial stone having a controlled thickness.

### BACKGROUND OF THE INVENTION

Engineered stones (also known in the art as artificial stones, agglomerated stone or quartz slabs) are widely used as building materials e.g., for kitchen countertops, work surfaces, indoor and outdoor floors, wall claddings, dressing tables, bathtubs, washbowls, and interior articles. Artificial stone products are in great demand due to their ability to be manufactured in a wide variety of patterns and colors that cannot be found in nature and to show superior physical and mechanical performance when compared to natural stone.

These artificial stones are generally manufactured by mixing 5-20 wt. % unsaturated polyester thermoset or acrylic thermoset compositions and aggregate and/or mineral, in a single layer. The unsaturated polyester thermoset compositions comprise an oligomeric chain comprised of saturated dicarboxylic acids or its anhydride as well as unsaturated dicarboxylic acid or anhydride. These two acids are reacted with one or more di-alcohols. The Resin mixture also comprises a reactive solvent, e.g., styrene, and cobalt-octoate as a curing process accelerator. The acrylic thermoset compositions comprise monomeric units selected from acrylate, methacrylate, and any derivative thereof and a crosslinker. The aggregate and/or mineral can be any type of quartz, quartzite, feldspar, glass particles, clay, calcium carbonate, aluminum hydroxide, magnesium hydroxide, or any combination thereof. The mixture is substantially homogeneous across the entire slab.

These mixtures have limited fluidity and are hard to layer. In order to maintain substantially homogeneous thickness across the slab prior to pressing and curing, relatively thick layers (e.g., having a thickness larger than 30 mm, for example, 50 mm or 75 mm) are spread on a conveyor. Thinner slabs, although difficult to manufacture have an elegant appearance, may be suitable for additional applications (wall coverage), and may reduce costs for covering any certain surface by using less raw material per sqm.

Therefore, there is a need for a production system that may allow producing slabs in a wide optional thickness, from thin slabs (e.g., 6 mm) to thick slabs (e.g., 30 mm).

### SUMMARY OF THE INVENTION

Some aspects of the invention are directed to a system for making an artificial stone, comprising: a weighing and dosing unit; an upper conveyor positioned to receive an artificial stone mixture from a bottom exit of the weighing and dosing unit, wherein the artificial stone mixture comprises an inorganic filler and a polymeric binder; a lower conveyor, located partially under the upper conveyor, positioned to receive the artificial stone mixture from the upper conveyor; and a crushing cylinder located against distal rotating axes of the lower conveyor at a distance of 1 to 20 mm from the lower conveyor, rotating at a tangential speed which is at least twice higher than the speed of the lower conveyor, wherein the crushing cylinder is configured to lay and unify the artificial stone mixture on a final conveyor.

In some embodiments, the speed of the lower conveyor is at least 1.5 times higher than the speed of the upper conveyor.

In some embodiments, the system further comprises an upper crusher, configured to rotate with the mixture progression direction, located between the upper conveyor and the lower conveyor and configured to crush and increase the uniformity of the mixture during laying of the mixture on the lower conveyor. In some embodiments, a rotational speed to the upper crusher is between 10 to 250 RPM.

In some embodiments, the system further comprises a lower crusher, configured to rotate against the mixture progression direction, and located above the lower conveyor prior to the crushing cylinder. In some embodiments, a rotational speed to the lower crusher is between 10 to 250 RPM. In some embodiments, a diameter of the crushing cylinder is between 200 to 400 mm. In some embodiments, a length of the lower conveyor is between 400 to 1000 mm.

In some embodiments, a diameter of the distal rotating axes of the lower conveyor is between 80 to 150 mm/sec. In some embodiments, a speed of the upper conveyor is between 100 to 300 mm/sec. In some embodiments, a speed of the lower conveyor is between 100 to 1500 mm/sec. In some embodiments, a rotational speed of the crushing cylinder is between 100 to 3000 RPM.

In some embodiments, the system further comprises a press configured to press the flattened artificial stone mixture laid on the final conveyor into a slab. In some embodiments, the system further comprises a heating unit for hardening the pressed slab.

Some additional aspect of the invention may be directed to a method of controlling a thickness of an artificial stone slab, comprising: continuously providing an artificial stone mixture to a weighing and dosing unit, wherein the artificial stone mixture comprises an inorganic filler and a polymeric binder; continuously pouring the artificial stone mixture from the bottom exit of the weighing and dosing unit onto an upper conveyor; continuously conveying the crushed artificial stone mixture using a lower conveyor moving at a speed that is at least 1.5 times higher (e.g., 10) than the speed of the upper conveyor; finely crushing and flattening the artificial stone mixture between the lower conveyor and a crushing cylinder located against a distal rotating axis of the lower conveyor at a distance of 1 to 20 mm from the lower conveyor, and rotating at a tangential speed which is at least twice higher (e.g., 3) than the speed of the lower conveyor; and continuously laying the crushed and unified artificial stone mixture on a final conveyor; and continuously pressing, by a press, the flattened artificial stone mixture laid on the final conveyor, into a slab, wherein the speed of the upper conveyor, the speed of the lower conveyor, and the tangential speed of the crushing cylinder are determined accoridng to ensure a required thickness of the slab.

In some embodiments, the method may further include crushing the artificial stone mixture by an upper crusher, located between the weighing and dosing unit and the slow conveyor.

In some embodiments, the method may further include flattening the mixture on the lower conveyor using a lower crusher, configured to rotate against the mixture progression direction, and located above the lower conveyor prior to the crushing cylinder.

In some embodiments, the method may further include comprising hardening the slab by heating the pressed artificial stone mixture.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A, 1B, and 1C are illustrations of systems for making an artificial stone accoridng to some embodiments of the invention;

FIG. 2 is a flowchart of a method of controlling a thickness of an artificial stone slab according to some embodiments of the invention;

FIGS. 3A and 3B are images of an in-process and final product of a slab accoridng to some embodiments of the invention;

FIGS. 4A and 4B are graphs showing the flexural resistance and the impact resistance as a function of slab thickness accoridng to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. The scope of the invention is thus indicated by the appended claims, rather than by the foregoing description, and all changes that come within the meaning and range of equivalency of the claims are therefore intended to be embraced therein.

Some aspects of the invention may be directed to a system and method for making an artificial stone having a controlled thickness. The system may allow producing slabs in a wide optional thickness, from thin slabs (e.g., 6 mm) to thick slabs (e.g., 30 mm). A slab is formed by spreading an artificial stone mixture made from an inorganic filler (e.g., aggregates) and a polymeric binder, on a conveyor, followed by pressing and hardening. The artificial stone mixture is a wet thick clustered composition with very limited to no fluidity. When spread on the conveyor the mixture comprises 50 mm to-100 mm clusters made of aggregates attached together by the polymeric binder. Therefore, in order to form a thin slab, the thick mixture must be evenly and finely spread to form a homogeneous thin layer comprising very fine clusters of not more than 50 mm. (e.g., no more than 40 mm, 35 mm, 30 mm 25 mm, and 20 mm).

In some embodiments, the mixture may include at least 80 wt. % of an inorganic filler. In some embodiments, the inorganic filler is selected from quartz, feldspar, quartzite amorphous silica, glass particles, frits, or any combination thereof. In some embodiments, the inorganic filler (or aggregates) is in the form of a plurality of particles having a median diameter ranging from 0.001 to 10 mm or more. In some embodiments, the inorganic filler may include a mixture of two or more types of aggregates, for example, 50 wt. % quartzite and 50 wt. % quartz, or 20 wt. % quartzite and 80 wt. % quartz.

In some embodiments, the mixture may include at least 5 wt. % of polymeric binder. In some embodiments, the polymeric binder may include, acrylic binder, epoxy, polyurethane, polyester (e.g., unsaturated polyester), and any combination thereof. In some embodiments, the acrylic binder may include a plurality of monomeric units selected from acrylate, or any derivative thereof.

In some embodiments, the acrylate is selected from methacrylate, methyl methacrylate (MMA), 2-ethylhexyl acrylate (2-EHA), 2-ethylhexyl methacrylate, n-butyl acrylate, n-butyl methacrylate, isobutyl methacrylate, isobornyl acrylate, isobornyl methacrylate, and any derivative or combination thereof. In some embodiments, the monomeric unit comprises 2-EHA and MMA. In some embodiments, the MMA and 2-EHA are present at a weight ratio ranging from 5:1 to 3:1, respectively.

In some embodiments, the polymeric binder may be cross-linked. For example, cross-linked acrylic polymer may include a cross-linker selected from the group comprising of: triethylene glycol diacrylate, trimethylolpropane triacrylate (TMPTA), trimethylolpropane trimethacrylate (TMPTMA), pentaerythritol tetraacrylate, dipentaerithritol hexaacrylate, dendritic acrylates, and methacrylates having at least two functional groups, or any derivative or combination thereof.

In another example, cross-linked polyester may include styrene, triethylene glycol diacrylate, triethylene glycol dimethacrylate or any derivative or combination thereof.

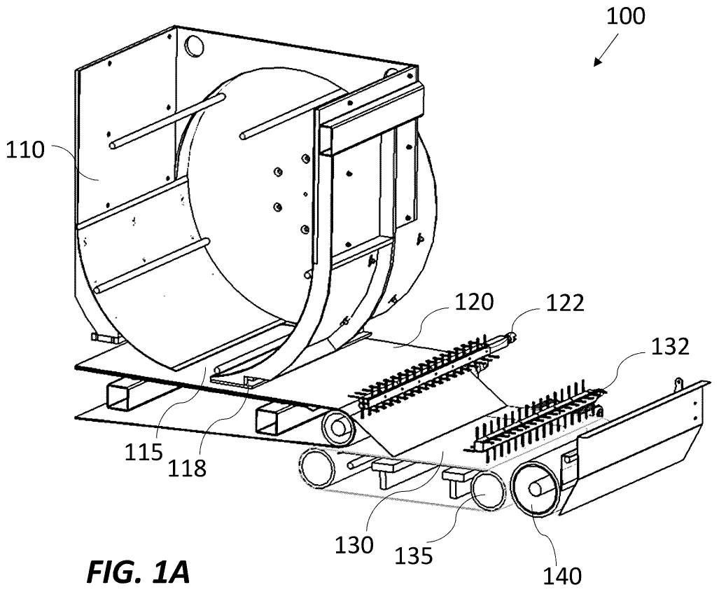

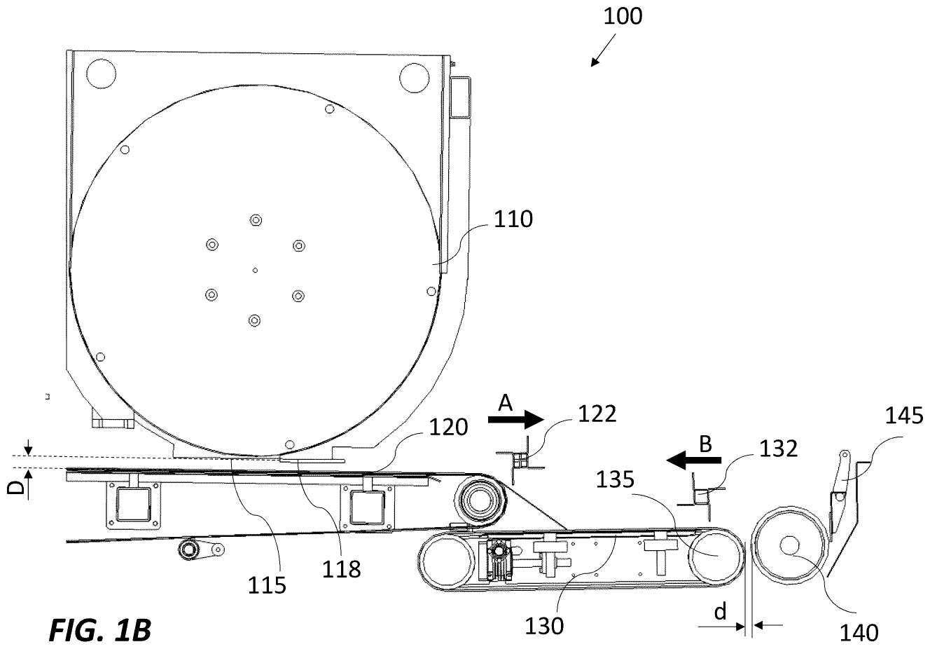

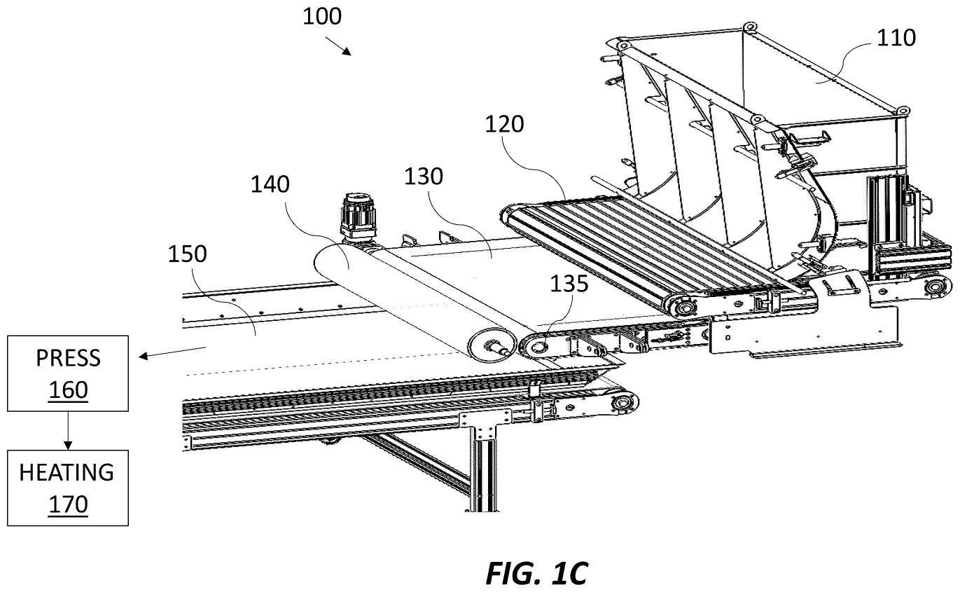

Reference is now made to FIGS. 1A, 1B, and 1C which are illustrations of systems for making an artificial stone accoridng to some embodiments of the invention. A system 100 may include a weighing and dosing unit 110, also known in the art as, distribution trolly. In some embodiments, weighing and dosing unit 110 may be configured to provide a controllable amount of artificial stone mixture to an upper conveyor 120. Weighing and dosing unit 110 may weigh and hold the artificial stone mixture and may include an outlet 115 configured to spread the artificial stone mixture on conveyor 115. Outlet 115 may include a leveling bar 118 for evenly leveling and spreading the artificial stone mixture on upper conveyor 120. In some embodiments, a distance D between bar 118 and upper conveyor 120 may be between 20 to 150 mm, for example, 30 to 100 mm, 40 to 90 mm, and any value in between. The distance may be adjusted to define the amount of material provided from weighing and dosing unit 110 to conveyor 120. The smaller distance D is, the thinner the final slab will be.

In some embodiments, the amount of artificial stone mixture provided during each batch may vary between 150 to 400 Kg. For example, between 170 to 350 Kg, 200 to 300 Kg or any value in between.

In some embodiments, upper conveyor 120 may be configured to move at a speed of 100 to 300 mm/sec.

System 100 may further include a lower conveyor 130, located partially under upper conveyor 120, positioned to receive the artificial stone mixture from upper conveyor 120. In some embodiments, the length of lower conveyor 130 (e.g., between the two rotating axes) is between 200 to 2000 mm, for example, between 400 to 1000 mm, 300 to 700 mm, 500 to 600 mm, and any value in between. In some embodiments, a diameter of the distal rotating axis 135 of the lower conveyor is between 50 to 200 mm, for example, between 75 to 180 mm, between 80 to 150 mm, 90 to 140 mm and any value in between. In some embodiments, a speed of lower conveyor 130 is between 100 to 1500 mm/sec, for example, between 150 to 1200 mm/sec, between 200 to 1100 mm/sec, between 300 to 1000 mm/sec and any value in between.

In some embodiments, the speed of lower conveyor 130 is at least 1.5 times higher than the speed of upper conveyor 120. For example, the speed of lower conveyor 130 may be at least, twice, 3-times, 4-times, 5-times, 6-times, 7-times, 8-times, 9-times, 10-times of more higher than the speed of upper conveyor 120.

In some embodiments, system 100 may further include a crushing cylinder 140 located against distal rotating axis 135 of lower conveyor 130 at a distance d of 1 to 20 mm from lower conveyor 130. Crushing cylinder 140 may rotate at a tangential speed which is at least twice higher than the speed of lower conveyor 130. In some embodiments, crushing cylinder 140 is configured to lay and flatten the artificial stone mixture on a final conveyor 150 (illustrated in FIG. 1C).

In some embodiments, crushing cylinder 140 may rotate at a tangential speed which is at least three times higher than the speed of lower conveyor 130. For example, the tangential speed may be 4-times, 5-times, 6-times, 7-times, 8-times, 9-times, 10-times of more higher than the speed of lower conveyor 130. For example, if the speed of the lower conveyor is 300 mm/sec the tangential speed of crushing cylinder 140 may be 600 mm/sec, 900 mm/sec, 1200 mm/sec or higher.

In some embodiments, a diameter of crushing cylinder 140 is between 150 to 500 mm, for example, between 200 to 400 mm, 250 to 300 mm or any value in between. In some embodiments, the rotational speed of crushing cylinder 140 is between 100 to 3000 RPM.

In some embodiments, crushing cylinder 140 may be made or may include any suitable material, for example, a metallic alloy coated with a hard polymeric coating having, for example, 70 to 90 Shore A hardness. In some embodiments, other materials or coatings may be used, for example, crushing cylinder 140 may be at least partially covered with brushes, bumps, pins, etc.

In some embodiments, system 100 may further include an upper crusher 122 configured to rotate with the mixture progression direction (denoted as arrow A). Upper crusher 122 may be located between upper conveyor 120 and lower conveyor 130 and configured to crush and increase the uniformity of the mixture during the laying of the mixture on lower conveyor 130. In some embodiments, upper crusher 122 may include a plurality of pins radially attached to a shaft of crusher 122. In some embodiments, the rotational speed to the upper crusher is between 10 to 250 RPM, for example, between 10 to 100 RPM, between 20 to 120 RPM, between 50 to 150 RPM, between 50 to 200 RPM, between 70 to 250 RPM or any value in between.

In some embodiments, system 100 may further include a lower crusher 132, configured to rotate against the mixture progression direction (denoted as arrow B). Lower crusher 132 may be located above lower conveyor 130 prior to crushing cylinder 140. In some embodiments, the rotational speed of the lower crusher is between 10 to 250 RPM, for example, between 10 to 100 RPM, between 20 to 120 RPM, between 50 to 150 RPM, between 50 to 200 RPM, between 70 to 250 RPM or any value in between.

In some embodiments, system 100 may further include a press 160 configured to press the flattened artificial stone mixture laid on a final conveyor 150 into a slab.

In some embodiments, system 100 may further include a heating unit 170 for hardening the pressed slab. For example, heating unit 170 may include heating elements, radiating elements, (e.g., a standard Breton oven) and the like. In some embodiments, heating the artificial stone mixture may cause curing the mixture, thus hardening the mixture into final hardness.

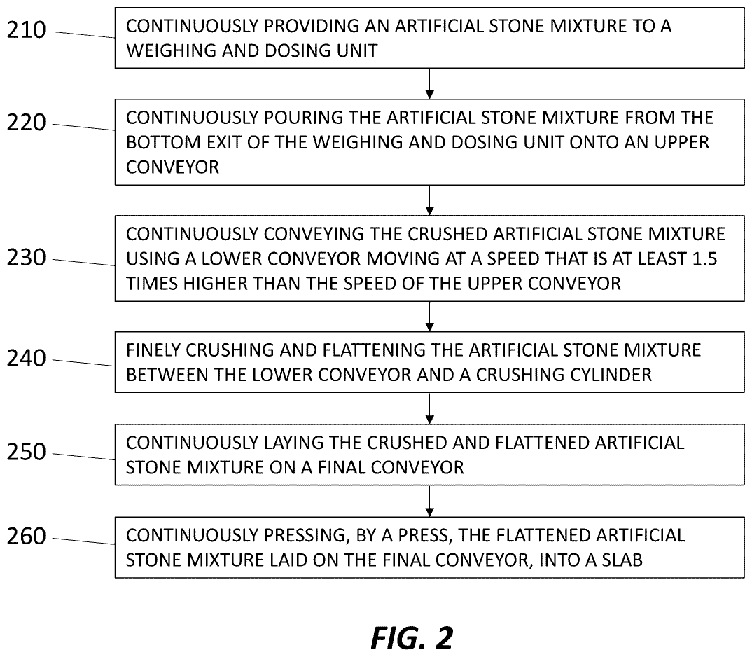

Reference is now made to FIG. 2 which is a flowchart of a method for controlling a thickness of an artificial stone slab accoridng to some embodiments of the invention. The method of FIG. 2 may be performed using system 100.

In step 210, an artificial stone mixture may continuously be provided to a weighing and dosing unit. In some embodiments, the artificial stone mixture may include at least 80 wt. % of an inorganic filler. In some embodiments, the inorganic filler is selected from quartz, feldspar, quartzite amorphous silica, glass particles, frits, or any combination thereof. In some embodiments, the mixture may include at least 5 wt. % of polymeric binder. In some embodiments, the polymeric binder may include, acrylic binder, epoxy, polyurethane, polyester (e.g., unsaturated polyester), and any combination thereof. In some embodiments, the acrylic binder may include a plurality of monomeric units selected from acrylate, or any derivative thereof.

In step 220, the artificial stone mixture may be continuously poured from the bottom exit of the weighing and dosing unit onto an upper conveyor. For example, between 170 to 350 Kg of the artificial stone mixture may be poured from exit 115 of weighing and dosing unit 110 onto upper conveyor 120.

In step 230, the poured artificial stone mixture may continuously be conveyed using a lower conveyor moving at a speed that is at least 1.5 times higher (e.g., 10) than the speed of the upper conveyor. For example, the artificial stone mixture spread on top of upper conveyor 120 may be poured onto lower conveyor 130, for example, via upper crusher 122. Upper crusher 122 may crush the coarse clusters of the artificial stone mixture prior to spreading the artificial stone mixture on lower conveyor 130. The speed differences between upper conveyor 120 to lower conveyor 130 may ensure that a fine thin layer of the crushed mixture is spread on lower conveyor 130.

In step 240, the artificial stone mixture may be finely crushed and flattened between the lower conveyor and a crushing cylinder located against a distal rotating axis of the lower conveyor at a distance of 1 to 20 mm from the lower conveyor. In some embodiments, the crushing cylinder may rotate at a tangential speed which is at least twice higher (e.g., 3) than the speed of the lower conveyor. In some embodiments, the mixture crushed by crushing cylinder 140 may be spread to form a uniform layer of the artificial stone mixture on final conveyor 150 (step 250). In some embodiments, the artificial stone mixture may first be pre-crushed by lower crusher 132, prior to entering a gap (having a distance d) between lower conveyor 130 and crushing cylinder 140.

The outcome of this process is a highly uniform layer of artificial stone mixture, comprising fine clusters, having a thickness of, no more than 50 mm, for example, 40 mm, 6-30 mm, 20 mm or less. In some embodiments, the speed of the upper conveyor, the speed of the lower conveyor, and the tangential speed of the crushing cylinder are determined to ensure a required thickness of the slab.

In step 260, the flattened artificial stone mixture laid on the final conveyor, may be pressed into a slab. For example, the flattened artificial stone mixture laid on final conveyor 150 may be pressed by press 160 into a uniform slab having a thickness of between 6-30 mm.

In some embodiments the slab may be hardened by heating, for example, using a standard Breton oven.

### Experimental Results

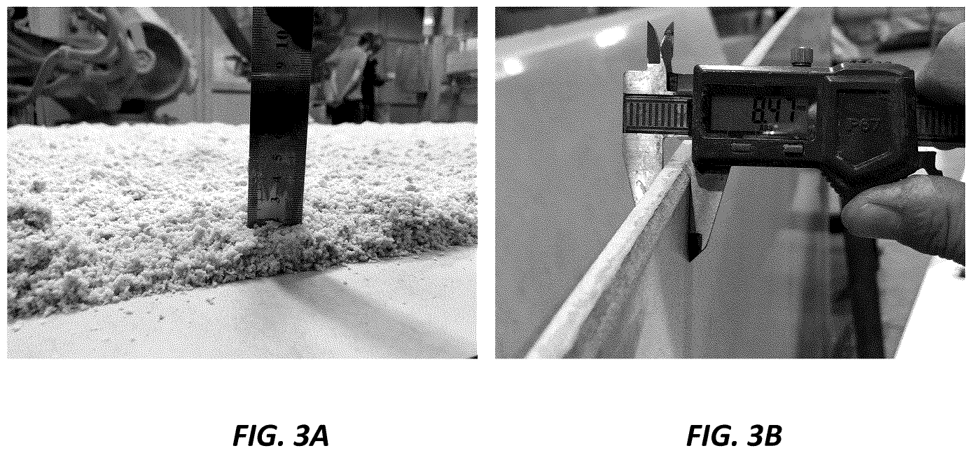

Reference is now made to FIGS. 3A and 3B which are images of an in-process and final product of a slab accoridng to some embodiments of the invention. FIG. 3A shows the crushed mixture after finely crushing, spreading and flattening (step 250) the mixture on the conveyor. FIG. 3B shows the final product after pressing and hardening. As shows, the final slab is less than 8.5 mm thick, has uniform appearance with no visible cracks.

The slab shown in FIG. 3B was fabricated using the method of FIG. 2 ad system 100.

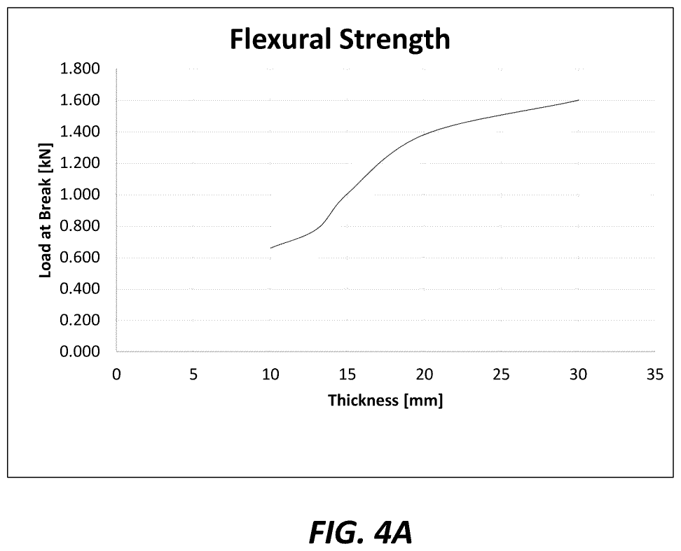

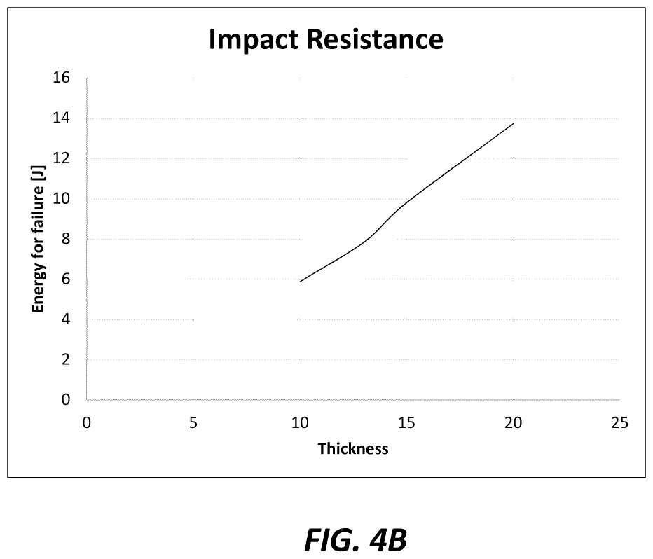

Reference is now made to FIGS. 4A and 4B are graphs showing the flexural resistance and the impact resistance as functions of slab thickness accoridng to some embodiments of the invention. FIG. 4A shows the flexural strength vs. slab thickness. The flexural strength influences the over-hang ability of the slab. As shown the load at break for the thinner slab was already 0.7 [kN], the thicker the slab the higher the flexural strength.

FIG. 4N shows the impact resistance as a function of slab thickness. The impact resistance influences the slabs cracking resistance. The energy for failure of the thinner slab (10 mm thick) was 6 [J] the thicker the slab the higher the impact resistance.

Despite the above results, the inventors have surprisingly found that the final slab may have improved properties even at low thicknesses. The slab had an improved density, the method reduced the production cycle time by between 10 to 20%, substantially reducing waste (e.g., at least 20 Kg waste of each slab of 200 Kg) as materials are already uniform. The method further reduces 5% of the defects in the slabs (e.g., reducing dramatically the paper cracks defect).

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A system for making an artificial stone, comprising:
a weighing and dosing unit;
an upper conveyor positioned to receive an artificial stone mixture from a bottom exit of the weighing and dosing unit, wherein the artificial stone mixture comprises an inorganic filler and a polymeric binder;
a lower conveyor, located partially under the upper conveyor, positioned to receive the artificial stone mixture from the upper conveyor; and
a crushing cylinder located against distal rotating axes of the lower conveyor at a distance of 1 to 20 mm from the lower conveyor, rotating at a tangential speed which is at least twice higher than the speed of the lower conveyor, wherein the crushing cylinder is configured to lay and unify the artificial stone mixture on a final conveyor.

2. The system of claim 1, wherein the speed of the lower conveyor is at least 1.5 times higher than the speed of the upper conveyor.

3. The system of claim 1, further comprising an upper crusher, configured to rotate with the mixture progression direction, located between the upper conveyor and the lower conveyor and configured to crush and increase the uniformity of the mixture during laying of the mixture on the lower conveyor.

4. The system of claim 3, wherein a rotational speed to the upper crusher is between 10 to 250 RPM.

5. The system of claim 1, further comprising a lower crusher, configured to rotate against the mixture progression direction, and located above the lower conveyor prior to the crushing cylinder.

6. The system of claim 3, wherein a rotational speed to the lower crusher is between 10 to 250 RPM.

7. The system of claim 1, wherein a diameter of the crushing cylinder is between 200 to 400 mm.

8. The system of claim 1, wherein a length of the lower conveyor is between 400 to 1000 mm.

9. The system of claim 1, wherein a diameter of the distal rotating axes of the lower conveyor is between 80 to 150 mm/sec.

10. The system of claim 1, wherein a speed of the upper conveyor is between 100 to 300 mm/sec.

11. The system of claim 1, wherein a speed of the lower conveyor is between 100 to 1500 mm/sec.

12. The system of claim 1, wherein a rotational speed of the crushing cylinder is between 100 to 3000 RPM.

13. The system of claim 1, further comprising a press configured to press the flattened artificial stone mixture laid on the final conveyor into a slab.

14. The system of claim 13, further comprising a heating unit for hardening the pressed slab.
